(19) United States
(12) Patent Application Publication
(10) Pub. No.: US 2003/0223567 A1
(43) Pub. Date: Dec. 4, 2003

(54) Method and terminal for transferring concerned messages relating to the status and/or changes in the status of a terminal

(76) Inventors: Karlheinz Hafner, Munich (DE); Ansgar Troester, Munich (DE); Joern Watzke, Moosburg (DE)

Correspondence Address: BELL, BOYD & LLOYD, LLC, P. O. BOX 1135, CHICAGO, IL, 60690-1135, US

(21) Appl. No.: 10/362,246

(22) PCT Filed: Aug. 6, 2001
(86) PCT No.: PCT/EP01/09070

(51) Int. Cl. H04M 7/00

(52) U.S. Cl. 379/219; 379/88.22

(57) ABSTRACT

The invention relates to a method for transferring messages relating to the status and/or changes in the status devices (GEG, GEG′, GEG″) which can be connected to a line-bound telecommunication network (BTN), wherein a status message is created and/or at least one predetermined status message is called by a state and/or the device. The status report contains information concerning change in the state of the device. Subsequently, a network connection is set up by the device and at least one status report is transmitted via the network connection to at least one predetermined address. The invention also relates to a device (GEG, GEG′, GEG″) for carrying out the inventive method.

The invention relates to a method for transmitting messages relating to states of and/or state changes in appliances which can be connected to a line-connected telecommunications network.

The invention likewise relates to an appliance which can be connected to a line-connected telecommunications network, having a control device and a memory device.

To check the state of various appliances such as telephone answering machines, heating systems, telephone installations, etc., it is usually necessary for the user to visit the site of the respective appliances in order to check the state of the appliance. By way of example, the user can also use information output from the respective appliance, for example on a display on the appliance, or a signal tone to find out about a state change from the state of or the state change in the appliance, and, if necessary, can take further actions regarding the state or configuration of the appliance.

If these appliances are associated with a telecommunications network—particularly a line-connected network (landline network)—, then some appliances also allow the state of the respective appliance in the telecommunications network to be checked remotely. Such remote checking is known particularly in the case of telephone answering machines, where the user makes a call to the appliance. The appliance—in this case the telephone answering machine—can then communicate its state, for example by means of a particular tone sequence or by means of prescribed, stored voice messages, for example whether and how many calls have been received on the appliance.

If the user should subsequently wish to find out more details about the “state”, for example listen to messages received on the telephone answering machine, or make configuration settings on the appliance, for example, then he needs to authenticate himself by entering a PIN code (“Personal Identification Number”), for example, which is transmitted to the appliance using the dual tone multifrequency method (“DTMF”), for example.

A drawback of this practice is that the state of the appliance is transmitted to the user only on the basis of an activity by said user. The user is informed about the state of or about state changes in an appliance only if he sends a request to the respective appliance. This means that the situation can arise in which an important state change remains unknown to the user for a relatively long time because he has not performed a check.

A situation which arises with similar frequency is that in which the user performs a state check without the state of the appliance actually having changed. This is a drawback for the reason that, firstly, such a check has a certain associated time involvement, and such a check has associated costs on account of the call which needs to be made to the appliance.

It is an object of the invention to demonstrate a way in which a user can be quickly and reliably informed about state changes in an appliance which can be connected to a line-connected telecommunications network without the user himself needing to become active for this purpose.

This object is achieved by a method of the type mentioned in the introduction in which, in line with the invention, upon the occurrence of a prescribable event, in step

a) the appliance initiates the production of at least one status message and/or the calling of at least one prescribed status message, the status message containing information regarding the state of and/or a state change in the appliance, and then in step

b) the appliance initiates setup of a network connection and transmission of the at least one status message via the network connection to at least one prescribable address.

The effect achieved by the invention is that a user can find out about the state of various appliances connected to a line-connected telecommunications network without himself needing to become active to do so. Depending on what events are prescribed, a status message relating to an appliance is produced and is transmitted via a landline connection initiated by the appliance to an address, for example to a call number for a mobile radio or for a landline telephone. In this way, the user can find out about the state of or about state changes in appliances connected to a line-connected telecommunications network on the basis of various criteria which he can stipulate.

In one advantageous embodiment of the invention, an appliance which can be connected to the telecommunications network via an appliance interface is used, with the at least one status message being produced by the appliance and/or at least one status message stored in a memory associated with the appliance being called, and the message being transmitted from the appliance via a network connection to the at least one address.

In another refinement of the invention, an appliance is used which can be connected to a telecommunications terminal in the telecommunications network, with the appliance initiating the production of at least one status message by the telecommunications terminal and/or the calling of at least one status message stored in the telecommunications terminal and/or in a memory associated with the appliance, and additionally the appliance initiating setup of a network connection by the telecommunications terminal and transmission of the at least one status message.

The inventive method is found to be particularly advantageous and expedient if, in the event of a state change in the appliance, the production and/or the calling of at least one status message and transmission thereof to at least one prescribable address is initiated. A user is thus informed simply and reliably about any state change in the appliances which are to be monitored, and can initiate any necessary steps for reconfiguring the appliance's settings etc.

To ensure optimum monitoring, it is also expedient if, in the event of a request to the appliance, the production and/or the calling of at least one status message and transmission thereof to at least one prescribable address are initiated. By way of example, the user can thus use a call, possibly with additional authentication, or a message, for example using a mobile radio or a landline, to check the current state of the appliance at any time, which provides additional security and control for the user.

For the purpose of continuous monitoring, it can finally also be expedient if the production and/or the calling of at least one status message and transmission thereof to at least one prescribable address are initiated at prescribable times.

In one preferred embodiment of the inventive method, the status message is put into a short message format in step a), and the short message produced in this way is transmitted using a short message service.

In this case, it is expedient if

a suitably specified data link layer is used to perform logical connection setup before the short message is transmitted, and

the short message is sent in the short message format to a short message service center in a suitably specified physical layer using DTMF or FSK off-hook signaling.

For carrying out the inventive method, an appliance of the type mentioned in the introduction is particularly suitable, in which, in line with the invention, the control device is set up so that, upon the occurrence of a prescribable event, it initiates the production of at least one status message and/or the calling of at least one prescribed status message, the status message containing information regarding the state of and/or a state change in the appliance, and said control device is additionally set up to initiate setup of a network connection and transmission of the at least one status message to at least one prescribable address.

The particular advantages and developments of the inventive appliance have already been illustrated with reference to the inventive method.

The invention together with further advantages is explained in more detail below with reference to the drawing, in which:

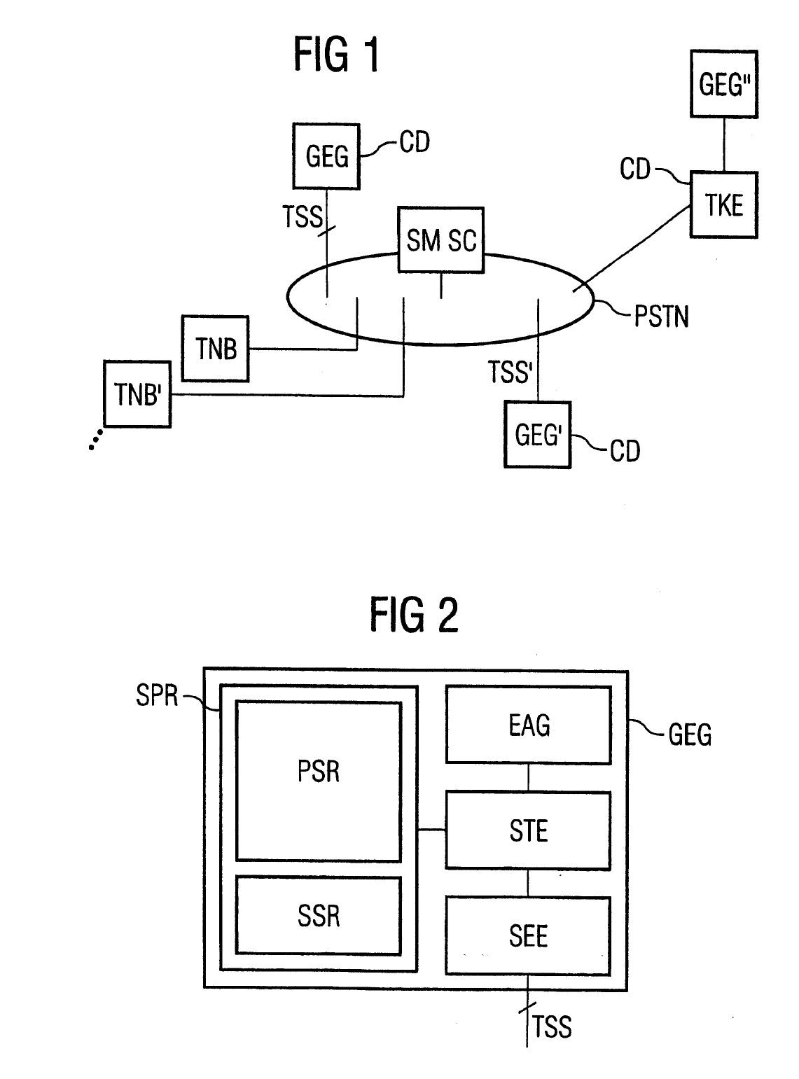

FIG. 1 shows a schematic overview of a telephone landline network in which the invention is implemented;

FIG. 2 shows an appliance for use with a method in accordance with the invention;

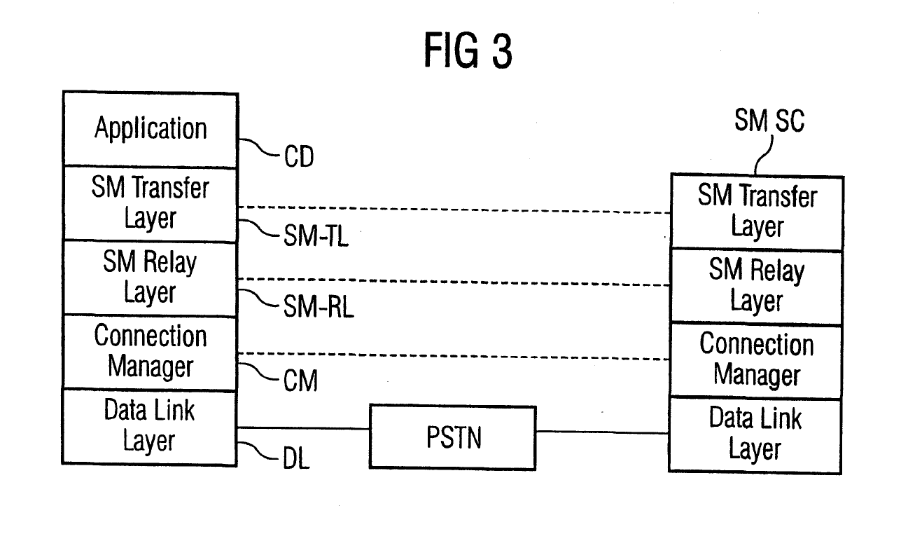

FIG. 3 shows an illustration of the layer model (SI model) for transmitting short messages relating to the configuration of a terminal and of a short message service center in the landline network shown in FIG. 1;

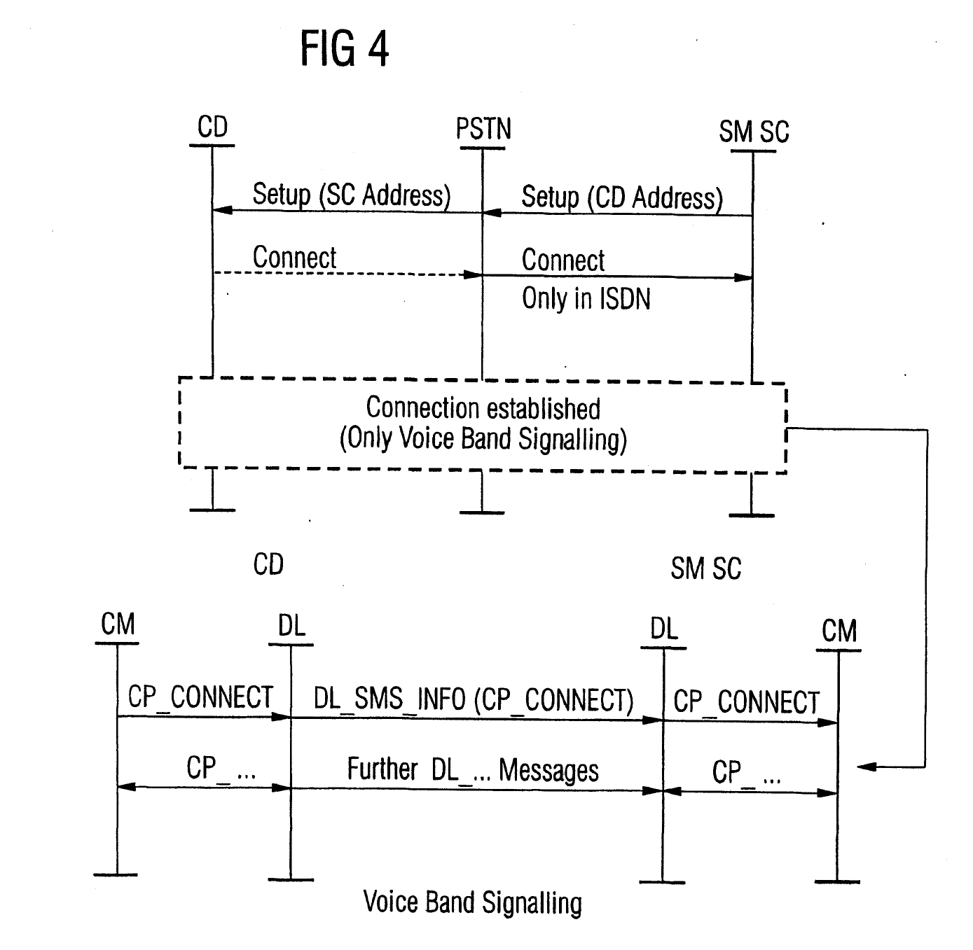

FIG. 4 shows a signaling diagram for connection setup, initiated by a (telecommunications) terminal, for transmitting short messages;

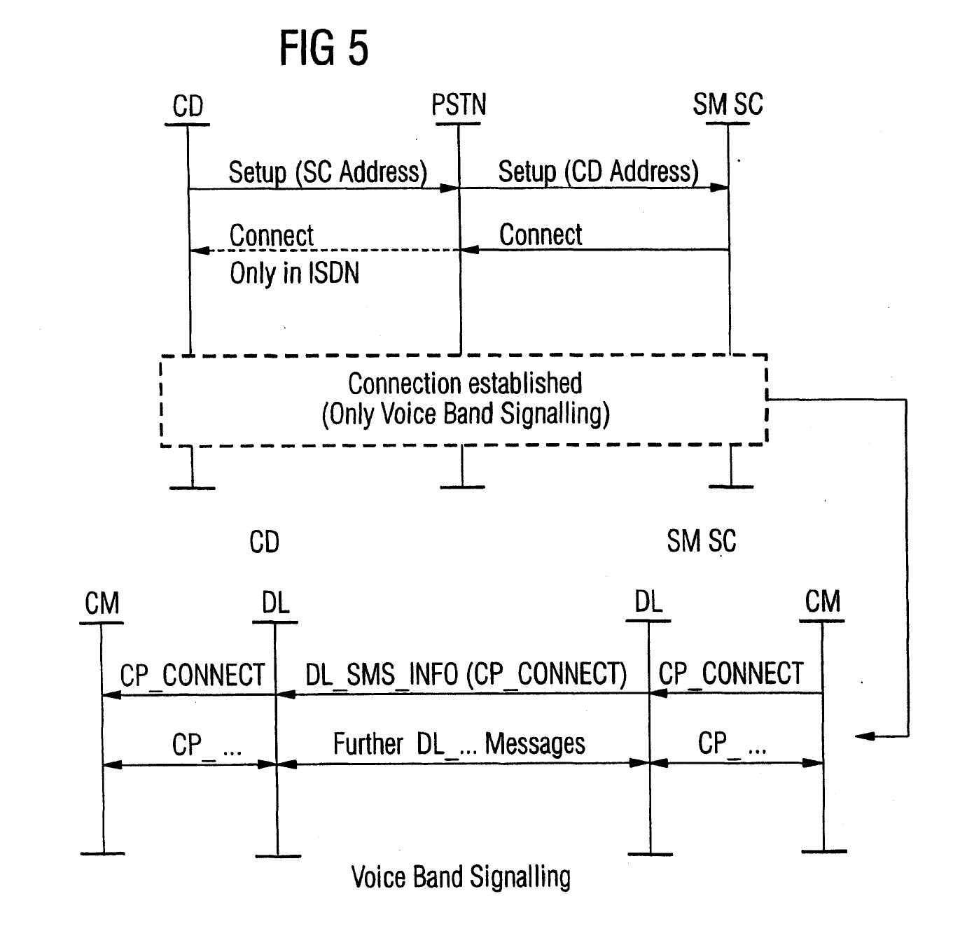

FIG. 5 shows a signaling diagram for connection setup, initiated by the short message service center, for transmitting short messages;

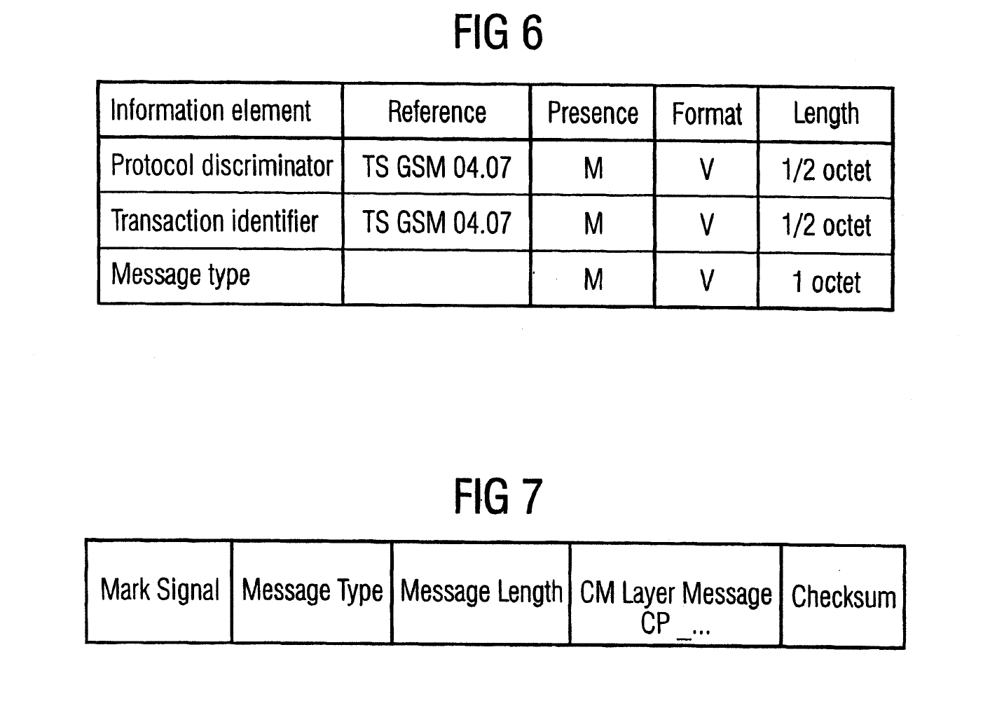

FIG. 6 shows an illustration of the structure of a message at the start of the short message transmission procedure on the connection management layer; and

FIG. 7 shows an illustration of the associated message format on the data link layer.

FIG. 1 shows a telephone landline network PSTN, for example an “a/b network” (often not quite appropriately also referred to as an analog network), to which a plurality of inventive appliances GEG, GEG′, GEG″ are connected, for example a telephone answering machine, a heating system, a telephone installation, etc. The appliances GEG, GEG′ are connected to the telephone network PSTN via a telephone interfaces TSS, TSS′ and are produced as devices for carrying out the invention; in addition, further terminals TNB, TNB′, . . . are shown which can be reached directly or via other telephone networks from the network PSTN. In addition, an appliance GEG″ is shown which is connected to a telecommunications terminal TKE, for example a telephone, in the telecommunications network PSTN.

FIG. 2 shows a terminal GEG which is connected to the telephone landline network PSTN and is set up to implement the invention. The terminal GEG has a transmission/reception unit SEE, which is used for implementing the communications functions with the landline network via the telephone interface TSS, and a memory SPR, a control device STE, e.g. in the form of a processor device, and an input/output EAG. The input/output EAG comprises, by way of example, a keypad and a display, or additionally—for example in the case of a telephone answering machine—a loudspeaker and a microphone as well. The input/output is used by the user to input and modify the appliance configurations and to check the respective state of the appliance.

The memory SPR, for example a read only memory PSR, in the terminal GEG stores the configurations for the appliance, information about the state or about state changes, and, for example in the case of a telephone answering machine, newly received or older messages. In addition, it can also be expedient if a read/write memory SSR is provided as a RAM memory, for example for handling messages as part of the memory device SPR.

The user may now wish to know, by way of example, whether new messages have been received on his telephone answering machine, or what operating state the heating system in his apartment is currently in.

By connecting a telephone answering machine, heating system GEG, GEG′, GEG″ etc. to a telephone network PSTN, it now becomes possible for the user to find out about the state of or state changes in his appliances without needing to be at the site of the respective appliance. In principle, there are various “events” whose occurrence results in the user being informed, these events easily being able to be prescribed by the user, for example using the input/output EAG on the appliance GEG, GEG′, GEG″. The terminal can naturally also have already been preconfigured accordingly at the factory.

The configurable and/or preconfigured events mentioned which result in the user being informed include those shown in the list below, which is not to be regarded as being complete:

a) the occurrence of a state change in the appliance GEG, GEG′, GEG″;

b) the user's checking the state of the appliance GEG, GEG′, GEG″; and

c) predetermined times being reached/exceeded.

When a particular, prescribed event occurs, a status message is produced, with this advantageously being done by the appliance in question. By way of example, the appliance changes state, for example as a result of a newly received message on a telephone answering machine or as a result of the heating system's changing to another heating mode, then the control device STE in the appliance GEG produces a status message containing information about the state change in the appliance. In addition, provision can also be made for the message to contain information relating to the new state and to the old state.

The control device STE forwards the status message to the transmission and reception unit SEE, which sends it to at least one prescribable address via a network connection which is set up for this purpose using the transmission/reception unit. In practice, it is often necessary and also readily possible for the message to be sent to a plurality of addresses as well. The address is advantageously a call number, for example the call number of a mobile radio belonging to the user, or an e-mail address; to this end, the status message is transmitted to the appropriate address using a messaging service supported by the landline network PSTN in a form which is suitable for the messaging service, using the connection requested for this purpose.

The event specified under point b) is easily implemented when remotely checking a telephone answering machine, as mentioned in the introduction to the description, although no message is transmitted to a particular address if, by way of example, a new voice message has been received; rather, a usually prestored spoken announcement about the “state” of the telephone answering machine, i.e. about the number of new messages received, is “merely” transmitted to the user.

The invention is of particular advantage if, as in the example described further above, a status message is automatically generated as soon as the state of the appliance GEG changes, and this message is sent to a prescribed address. It is particularly advantageous in this context if the status message is transmitted to the address using a messaging service, provided over the landline network, for transmitting messages in text format, in which case, in particular, an e-mail service (“electronic mail”) or an SMS service (Short Message Service) is particularly suitable for the purposes of the invention.

The SMS service, which allows particularly rapid notification of the user, is known from the GSM network and represents point-to-point transmission of short messages in that case. An example of an SMS service implemented in a line-connected telecommunications network is described in more detail further below in the section “Transmitting a message as a short message”. When using such an SMS service, it is possible to transmit a message content of up to 160 characters in length in a short message.

FIG. 2 shows an appliance GEG, for example a heating device, which has a dedicated transmission and reception device SEE which is used to transmit the status messages, generally produced by the appliance GEG itself, via a network link. Alternatively, provision can be made for particular states or state changes to have associated prescribed state messages which are stored in a memory associated with the appliance, such as in the memory SPR in the appliance GEG. These can then be called upon the occurrence of an event in line with the state changes, and can be transmitted using the transmission and reception unit.

In addition, it is also possible for the appliance GEG″ not to have a dedicated transmission and reception device, but rather to be connected to a telecommunications terminal TKE in the telecommunications network PSTN. Status messages are then generally not produced or called and sent by the appliance, but rather in this case messages are produced or prescribed messages are called by the telecommunications terminal TKE, this being initiated by the appliance GEG″.

Transmitting a Message as a Short Message

The SMS service is used for point-to-point transmission of short messages and, within the context of the GSM protocol architecture, is implemented on the signaling level. There, it comprises the transport of packet-oriented user data from and to mobile stations. The short messages are always transported via a short message service center (SM SC) in store-and-forward mode. The service center receives the short messages, which have a maximum length of 160 characters, from a mobile station as a telecommunications terminal and forwards them to a second telecommunications terminal—a further mobile station or else a fax machine or the like.

To implement the SMS service, the GSM standard defines a specific protocol architecture. This is stipulated in the ETSI specifications and is adequately described in the literature (cf. for example J. Eberspächer, H. J. Vögel: ‘GSM Global System for mobile communication’, Stuttgart, 1997), which means that a more precise description can be dispensed with at this point and reference can be made to the appended list of standards/documents.

The implementation used in the present case for the short message service in the landline network embraces the fundamental concept of mapping the tried-and-tested SMS protocol architecture from the GSM standard (or else a comparable architecture from the UMTS standard) onto the landline network to a certain extent and expanding it without giving consideration to the deep-rooted system differences between mobile radio networks, on the one hand, and the known line-connected networks, on the other.

The specifications described below define the transmission protocol and the physical and administrative prerequisites for transmitting short messages in the short message (SMS) format between the terminal and the short message service center. In this context, the transmission protocol is stipulated preferably in close imitation of the protocol defined in the GSM standard. This pursues the aim of making provision for the transmission of short messages as a service which is new to the landline network with little complexity and with high compatibility with the existing systems. A standard SMS format is used in the GSM network and in the landline network, as a result of which fluent transmission of short messages between a mobile radio network constructed and operated on the basis of the GSM standard and the landline network equipped in line with the invention is also ensured. In addition, the path taken with this form of the invention affords the considerable practical advantage that the specification of the SMS service can largely make use of the recognized and in the meantime tried-and-tested GSM specifications.

In the physical layer, data are transmitted between terminal station and service center using DTMF signaling and/or using FSK (Frequency Shift Keying) off-hook signaling specified in accordance with ETS 300 659-1 and ETS 300 659-2. These cited transmission methods can be used in any combination. In particular, a landline terminal can perform signaling using DTMF, and the service center can use FSK modulation, the respective receiving unit naturally needing to be matched to the method used.

Above the physical layer, a data link layer is specified which ensures logical connection setup and use of the GSM-SMS standard as a basis. The latter standard is defined particularly in ETSI documents GSM04.07 (ETS 300 556), GSM04.11 and GSM03.40. In compatibility with this, the data link layer can be defined freely in line with the specific requirements.

In line with one advantageous form of this solution, the newly defined physical layer and data link layer are combined with the existing layers of the GSM-SMS protocol set. These are the short message transfer layer (SM-TL) in line with ETSI document GSM 03.40, the short message relay layer (SM-RL) from GSM 03.40 and 04.11 and the connection management layer (CM) from GSM 04.11.

The last-mentioned layer CM specifically defines an additional message for signaling the connection state (CP-Connect), the format of which is determined in accordance with GSM 04.07, section 11. There is also a specific stipulation for the format of a message in the data link layer DL. This is discussed in more detail further below.

With reference to FIGS. 3 to 7, the text below illustrates the transmission of short messages using the example of short message exchange between a terminal station CD (representative of one of the devices GEG, GEG′, TKE in FIG. 1) and the short message service center SM SC connected to the landline network. The statements below for explaining the invention relate to the interplay of these components.

FIG. 3 shows the associated SI layer model, above the physical layer (not shown in this case). The layer structure first comprises a data link layer DL—specified in more detail further below—and also the following layers inherently known from the GSM-SMS standard: connection manager CM (Connection Manager), short message relay layer SM-RL (SM Relay Layer) and short message transfer layer SM-TL (SM Transfer Layer) and also—at the terminal station—the application layer (Application).

The protocol descriptions for the layers SM-TL, SM-RL and CM can be found in the ETSI documents GSM 03.40 and GSM 04.11.

The basic prerequisite for transmitting short messages over the landline network PSTN is connection switching between the units involved (terminal CD and short message service center SM SC). It is of no significance in this case whether the units are connected by means of ISDN or an analog interface.

FIGS. 4 and 5 show, schematically, setup of a connection from a telecommunications terminal station (FIG. 4) and from the short message service center (FIG. 5). These diagrams are self-explanatory to a person skilled in the art and therefore require no further explanation at this point. In the case of an ISDN network, the messages (Messages) are of a functional nature and are transmitted in the ISDN D-channel. In the case of an analog network, they are ringing pulses and busy signals. When the connection has been set up, all the information is transmitted between the units using FSK signaling in the voice band, specifically in line with ETSI specifications ETS 300 659-1 and ETS 300 659-2. FIG. 6 shows the structure of an additional message CP-Connect which is used to notify the calling unit from the called unit about setup of the connection. This notification is necessary in order to initiate proceedings in the CM layer. The message type coding is: 0x40=0100 0000B, and the format follows GSM 04.7, section 11.

The layer DL allows the connection manager (layer CM) to send and receive messages using the partner unit, and the latter provides bit error detection and implements a mark signal (Mark Signal) for a message in the layer CM.

FIG. 7 shows the format of a message in the data link layer. The field “Mark Signal” comprises a block of 80±25 bits. The field “Message Type” comprises one octet and contains a binary-coded identification number for the message. The coding for a DL_SMS_INFO Message Type is: 0x11=0001 0001B. The coding for a DL SMS ERROR Message Type is: 0x12=0001 0010B.

The “Message Length” field comprises one octet and contains the binary-coded number of octets in the message (with the exception of the octets for the Message Type, for the Message Length and for the Checksum). Overall, a message length of up to 255 octets is permitted. The “Checksum” field comprises one octet and contains the two complements for the sum of all the octets in the message, starting from the “Message Type” octet to the end, modulo 256.

In the case of a checksum error, the data link layer for the receiving unit sends a message of type “DL SMS_ERROR” to the (originally) sending unit. In this message, the data field is empty and the message length (Message Length) is set to zero. The data link layer for the sending unit then needs to repeat the last message sent.

With regard to the physical layer, it should also be noted that, in the case of FSK signaling, half-duplex 1200 band modulation can be used. In the case of DTMF signaling, every octet in a message in the data link layer is split into the higher (top) and lower (bottom) half bit. Each half bit is coded with one DTMF bit. First, the top half bit is sent and then the bottom one. In the case of DTMF signaling, the mark signal in the DL message is omitted.

With regard to the signaling method, various options for combination exist; in the normal case, the telecommunications terminal station CD has a selection permanently installed in it which cannot then be altered again by the user or service operator.

As already mentioned further above, the invention is found to be beneficial particularly if a status message about the state of an appliance is produced whenever a state change occurs on the appliance. Hence, the user can always be informed of changes precisely when such changes have actually occurred, and it is not necessary for the user to make a call to the appliance in order then possibly to establish that the state has not undergone any changes. So that the user is constantly able to “supervise” his appliances, it is advantageous, however, if the user can still perform specific state checks on his appliances. These state checks can be made, by way of example, by virtue of the user making a call to the desired appliance to be checked in the landline network or by virtue of his sending a short message or an e-mail of corresponding content to the appliance which the appliance then evaluates and replies to as appropriate with a status message. In this case, the user can also enter the address or further, additional addresses to which the message from the appliance needs to be transmitted in the short message or e-mail.

State messages sent by an appliance are transmitted to one or more addresses, generally prescribed by the user. In this case, a wide variety of options are possible, such as transmitting the message as a short message or e-mail, or a fax message can be transmitted to a particular fax number. It is also conceivable for the message to be transmitted by means of voice output by virtue of the appliance, for example, making a call to a prescribed number, and the voice message being sent upon answer. In this case, it may be appropriate for the appliance to ask for the entry of a code or of a code word before the message is sent in order to prevent unauthorized parties from outputting the corresponding information. Such a variant is advantageous in landline networks, in which there is no provision for an SMS service or other messaging service.

However, it is particularly advantageous if the corresponding messages are transmitted by the appliance connected to the landline network in the form of a short message to a telephone number, particularly a number for a mobile radio, preferably belonging to the user, since in this way the messages are transmitted quickly and in a form which has a good structure in terms of implementability and which can be stored.

For the purpose of archiving and subsequent counterchecking, it can finally also be advantageous if messages transmitted to an address are stored in the memory SPE, preferably in the read only memory PSR, in the appliance, where they can later be retrieved again by the user, if he so desires, using the input/output EAG.

1. A method for transmitting messages relating to states of and/or state changes in appliances (GEG, GEG′, GEG″) which can be connected to a line-connected telecommunications network (PSTN), characterized in that, upon the occurrence of a prescribable event, in step
a) the appliance (GEG, GEG′, GEG″) initiates the production of at least one status message and/or the calling of at least one prescribed status message, the status message containing information regarding the state of and/or a state change in the appliance (GEG, GEG′, GEG″), and then in step
b) the appliance (GEG, GEG′, GEG″) initiates setup of a network connection and transmission of the at least one status message via the network connection to at least one prescribable address.

2. The method as claimed in claim 1,
characterized in that an appliance (GEG, GEG′) which can be connected to the telecommunications network (PSTN) via an appliance interface (TSS, TSS′) is used, with the at least one status message being produced by the appliance (GEG, GEG′) and/or at least one status message stored in a memory (SPR) associated with the appliance (GEG, GEG′) being called, and the message being transmitted from the appliance (GEG, GEG′) via a network connection to the at least one address.

3. The method as claimed in claim 1,
characterized in that an appliance (GEG″) is used which can be connected to a telecommunications terminal (TKE) in the telecommunications network (PSTN), with the appliance (GEG″) initiating the production of at least one status message by the telecommunications terminal and/or the calling of at least one status message stored in the telecommunications terminal (TKE) and/or in a memory (SPR) associated with the appliance (GEG″), and additionally the appliance (GEG″) initiating setup of a network connection by the telecommunications terminal (TKE) and transmission of the at least one status message.

4. The method as claimed in one of claims 1 to 3, characterized in that, in the event of a state change in the appliance (GEG, GEG′, GEG″), the production and/or the calling of at least one status message and transmission thereof to at least one prescribable address are initiated.

5. The method as claimed in one of claims 1 to 4, characterized in that, in the event of a request to the appliance (GEG, GEG′, GEG″), the production and/or the calling of at least one status message and transmission thereof to at least one prescribable address are initiated.

6. The method as claimed in one of claims 1 to 5, characterized in that the production and/or the calling of at least one status message and transmission thereof to at least one prescribable address are initiated at prescribable times.

7. The method as claimed in one of claims 1 to 6, characterized in that the status message is put into a short message format in step a), and the short message produced in this way is transmitted using a short message service.

8. The method as claimed in claim 7,
characterized in that
a suitably specified data link layer (DL) is used to perform logical connection setup before the short message is transmitted, and
the short message is sent in the short message format to a short message service center (SM SC) in a suitably specified physical layer using DTMF or FSK off-hook signaling.

9. An appliance which can be connected to a line-connected telecommunications network (PSTN), having a control device (STE) and a memory device (SPR),
characterized in that the control device (STE) is set up so that, upon the occurrence of a prescribable event, it initiates the production of at least one status message and/or the calling of at least one prescribed status message, the status message containing information regarding the state of and/or a state change in the appliance (GEG, GEG′, GEG″), and said control device is additionally set up to initiate setup of a network connection and transmission of the at least one status message to at least one prescribable address.

10. The appliance as claimed in claim 9,
characterized in that it can be connected to the telecommunications network (PSTN) via an appliance interface (TSS, TSS′), additionally has a transmission and reception device (SEE) for transmitting and receiving messages via the appliance interface (TSS, TSS′), and the control device (STE) in the appliance (GEG, GEG′) is set up so that, upon the occurrence of prescribable events, it produces at least one status message and/or calls at least one status message stored in the memory (SPR) in the appliance (SPR) or in a memory associated with the appliance and transmits the message to at least one prescribable address.

11. The appliance as claimed in claim 9,
characterized in that it can be connected to a telecommunications terminal (TKE) in the telecommunications network (PSTN), and the control device (STE) is set up to initiate the production of at least one status message by the telecommunications terminal (TKE) and/or the calling of at least one status message stored in the telecommunications terminal (TKE) and/or in a memory (SPR) associated with the appliance (GEG″), and is additionally set up to initiate setup of a network connection and transmission of the at least one status message by the telecommunications terminal (TKE).

12. The appliance as claimed in one of claims 9 to 11, characterized in that it is set up so that, in the event of a request to the appliance (GEG, GEG′, GEG″), it initiates the production and/or the calling of at least one status message and transmission thereof to at least one prescribable address.

13. The appliance as claimed in one of claims 9 to 12, characterized in that it is set up to initiate the production and/or the calling of at least one status message and transmission thereof to at least one prescribable address at prescribable times.

14. The appliance as claimed in one of claims 9 to 13, characterized in that it is set up to put the status message into a short message format or to initiate production of said status message in a short message format and to transmit the short message using a short message service or to initiate sending of said short message using a short message service.

15. The appliance as claimed in claim 14,
characterized in that it is set up
to perform logical connection setup using a suitably specified data link layer (DL) before the short message is transmitted, and
to send the short message in the short message format to a short message service center (SM SC) in a suitably specified physical layer using DTMF or FSK off-hook signaling,
or to initiate performance of said points.
